(19) United States
(12) Patent Application Publication
(10) Pub. No.: US 2004/0212498 A1
(43) Pub. Date: Oct. 28, 2004

(54) Barrier movement arrangement human interface method and apparatus

(75) Inventors: Eric J. Peterson, Joliet, IL (US); Eric Gregori, Lindenhurst, IL (US)

Correspondence Address: FITCH EVEN TABIN AND FLANNERY, 120 SOUTH LA SALLE STREET, SUITE 1600, CHICAGO, IL, 60603-3406, US

(73) Assignee: The Chamberlain Group, Inc.

(21) Appl. No.: 10/424,404

(22) Filed: Apr. 28, 2003

(51) Int. Cl. G08B 1/08

(52) U.S. Cl. 340/539.25; 348/143

(57) ABSTRACT

A system for monitoring a movable barrier in which a small receiver box is wired in line between a television signal source and a television monitor. When the receiver box receives a signal from a garage door operator mounted near the garage door, a small icon is displayed in the corner of the television indicating that the door is open. This will place an indication of the status of the garage door right where many people are looking. Advantageously, many people watch television before going to bed and having an icon displayed exactly where they will be looking before falling asleep can help increase home security.

### FIELD OF THE INVENTION

The present invention relates generally to movable barriers, such as garage doors. More specifically, but without limitation thereto, the present invention relates a monitoring system for a movable barrier operator.

### BACKGROUND OF THE INVENTION

Movable barriers, e.g., garage doors, have typically been opened and closed manually by a user. More recently, moveable barriers have been connected to automatic movable barrier operators, e.g., garage door operators. This allows the movable barrier to be opened and closed through the activation of the movable barrier operator. In many instances, generally due to human error, a movable barrier whether manually operated or operated automatically, may be left open when the user intended that it be closed. In order to check the status of the movable barrier the user will go and look at the movable barrier to see if it is open or closed. Typically, however, a person will not remember to check whether the movable barrier has been left open or will remember at an inconvenient time.

Garage door status monitors such as is described in U.S. Pat. No. 5,402,105 to Doyle et al. are known in the art. A status monitor is attached to a garage door and equipped with a RF transmitter. An RF receiver which is limited to indicating barrier status, receives a signal from the RF transmitter and emits a tone and/or a visual indicator to signal that the garage door is open. However, if the user is not in the room where the RF receiver is located, the user will not be notified of the status of the garage door.

Thus there is a need for a monitoring system for a movable barrier which can solve the problems above.

### SUMMARY OF THE INVENTION

The arrangement described and claimed herein advantageously addresses the need as well as other needs by providing status indications about the barrier at times and locations convenient to a user.

One disclosed embodiment includes an apparatus comprising a movable barrier operator for controlling a movable barrier; and a receiver box, electronically coupled to the movable barrier operator, for sending a status image combined with a display signal to a viewing monitor such as a television set or a computer screen.

Another embodiment includes a method of sending a status image for a movable barrier comprising the steps of determining a status of the movable barrier; receiving a display signal from a signal source; and sending a status image and the display signal to a viewing monitor. Advantageously, the display signal may be a television program signal or a computer monitor signal.

Yet another embodiment includes a method of monitoring a movable barrier comprising the steps of receiving a status signal from a movable barrier operator; receiving a display signal from a signal source; combining the display signal and a status image to create a combined signal; and sending the combined signal to a viewing monitor; wherein the status image corresponds to the status signal.

A subsequent embodiment can be characterized as a method of sending a status image for a movable barrier comprising the steps of determining a status of the movable barrier; and sending a status image to a viewing monitor; wherein the status image is shown on the viewing monitor simultaneously with a display signal from a signal source.

An additional embodiment can be characterized as a method of monitoring a movable barrier comprising the steps of receiving a status signal from a status monitor; determining a status of the movable barrier; and outputting a status image signal for display on either a computer monitor or a television.

### BRIEF DESCRIPTION OF THE DRAWINGS

The present invention is illustrated by way of example and is not limited in the accompanying figures, in which like references indicate similar elements, and in which:

FIG. 1 is a block diagram illustrating a system for monitoring a movable barrier;

FIG. 2 is a block diagram illustrating a wireless system for monitoring a movable barrier;

FIG. 3 is a flow chart illustrating of one method in accordance with the embodiments shown in FIGS. 1 and 2; and

FIG. 4 is a perspective diagram illustrating a status monitor attached to a movable barrier.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE PREFERRED EMBODIMENTS

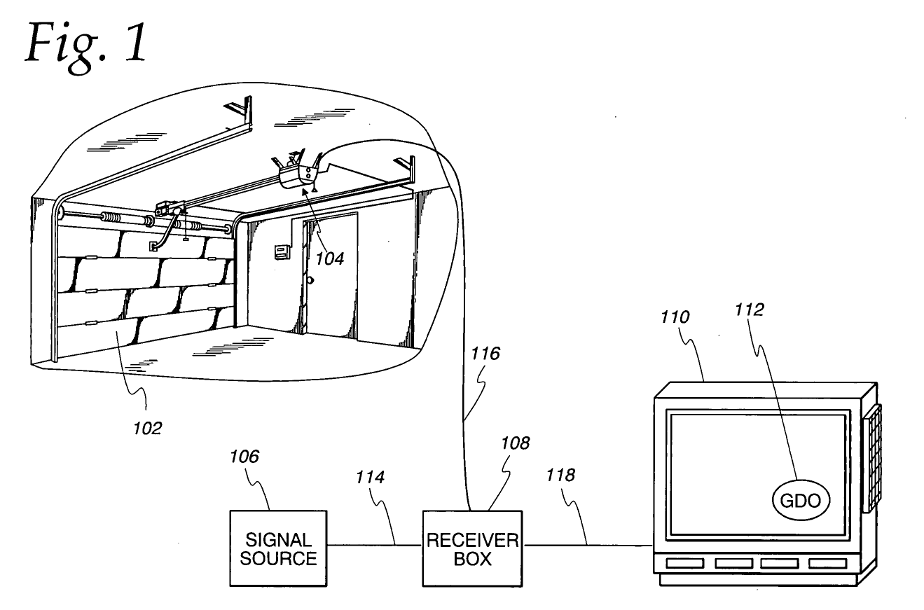

FIG. 1 illustrates a system for monitoring a movable barrier in accordance with an embodiment of the present invention. Shown is a movable barrier 102, a movable barrier operator 104, a signal source 106, a receiver box 108, a viewing monitor 110, a status image 112, a signal source input 114, a status input 116, and an output 118. The movable barrier 102 is coupled to the movable barrier operator 104. The movable barrier operator 104 is electrically coupled to a receiver box 108. The receiver box 108 is electrically coupled in-line between the signal source 106 and the viewing monitor 110.

The movable barrier operator 104 controls the movement of the movable barrier 102. Generally, the movable barrier 102 is either open or closed, or in the process of opening or closing. In one embodiment, the movable barrier operator 104 sends a status signal to the receiver box 108 indicating the status of the movable barrier, e.g., open, closed, currently opening, currently closing or position from a limit e.g., 1 inch from the floor. Additionally, the status signal can include many other types of information, e.g., failure modes of the movable barrier. Optionally, the movable barrier operator 104 sends the status signal to the receiver box 108 in response to a query from the receiver box 108.

The receiver box 108 determines whether to send the status image 112 to the viewing monitor 110 based upon the status signal. When the receiver box 108 determines that the status image 112 should be sent to the viewing monitor 110, the receiver box 108 combines the status image 112 with a display signal sent from the signal source 106 and sends the combined signal to the viewing monitor 110. The viewing monitor 110 then displays both the status image 112 and display signal. Thus, the status image 112 of the movable barrier 102 is shown in a very convenient location, namely, a portion of a television or computer screen.

The receiver box 108 determines whether to send the status image 112 to the viewing monitor 110 based upon the status signal. When the receiver box 108 determines the status image 112 should be sent to the viewing monitor 110, the receiver box 108 combines the status image 112 with a display signal sent from the signal source 106 and sends the combined signal to the viewing monitor 110. The viewing monitor 110 then displays both the status image 112 and display signal. Advantageously, the viewing monitor is a television picture tube or the display of a computer both of which are places frequented by persons interested in barrier status. The signal source may be a cable television feed or antenna output in the case of a television viewing monitor, or the source may be the video output of a computer. Thus, the status image 112 of the movable barrier 102 is shown in a very convenient location.

A user of the viewing monitor 110 is notified of the status of the movable barrier 102 through viewing of the status image 112. In one embodiment, the status image 112 is only shown on the viewing monitor 110 when the movable barrier 102 is open. Alternatively, the receiver box 108 determines the status of the movable barrier 102. The receiver box 108 determines whether to send the status image 112 to the viewing monitor 110 based upon the determination of the status of the movable barrier 102. For example, the receiver box may send the signal at a predetermined interval and when a change of status occurs. When the receiver box 108 determines the status image 112 should be sent to the viewing monitor 110, the receiver box 108 sends the display signal received from the signal source 106 and the status image 112 to the viewing monitor 110. The viewing monitor 110 then displays both the status image 112 and display signal. Alternatively, the receiver box 108 combines the display signal and the status image 112 into a combined signal. The combined signal is then sent to the viewing monitor 110 for display. The display of the status image 112 on the viewing monitor 110 conveniently notifies a user of the viewing monitor 110 of the status of the movable barrier 102.

In the embodiment shown in FIG. 1, the movable barrier 102 is a garage door, the movable barrier operator 104 is a garage door opener, the signal source 106 is a cable television signal and the viewing monitor 110 is a television. It should be understood, however, that the present invention is not limited to this environment and that many different components may be substituted. For example, the movable barrier 102 could be many types of movable barriers, including, but not limited to, a gate, a door, a garage door, and a window.

Similarly, the movable barrier operator 104 shown in FIG. 1 is employed for controlling the opening and closing of a conventional overhead garage door. It should be well understood that the movable barrier operator 104 shown in FIG. 1 is only one embodiment and many systems for controlling many movable barriers can be used in accordance with the present invention.

Additionally, the signal source 106 is described as a cable television signal. It should be well understood that the signal source 106 can be many signals, including, but not limited to a digital television signal, a broadcast signal, a satellite television signal, a signal sent over the internet, a VCR signal, a computer signal, and a game signal, e.g., a signal coming from a Microsoft X-Box. The signal source provides a display signal, e.g., a TV signal which will be combined with the status signal from the receiver box. The TV signal can be the signal which is received from the cable provider or the signal which is output from a standard television cable box, such as is known in the art. The status signal is combined with the signal from the television cable box and sent to the television. In the present embodiment, the television signal can be either a digital TV signal or an analog TV signal.

The viewing monitor 110 shown in FIG. 1 is a standard television set. The present invention is not limited to a standard television set and could be many types of viewing monitors, such as, but not limited to a liquid crystal display, a computer monitor, a lap top computer monitor, a projection television, a high definition television, and a flat panel television.

The receiver box 108 is shown with the output 118 to the viewing monitor 110. The output 118 of the receiver box 108 can be many types of outputs, such as for example, a coaxial output, an RCA output, a component video output, an infrared output, a S-Video output, a USB output and a RS-232 output. Additionally, the receiver box 108 can include a plurality of outputs including, e.g., any combination of the coaxial output, the RCA output, the component video output, the S-Video output, the USB output, and the RS-232 output.

In an alternative embodiment, the receiver box 108 is not wired in-line with the signal source 106. In this embodiment, the receiver box 108 determines the status of the movable barrier and sends a signal to, for example, a cable box or a computer. The cable box or the computer then combines the status image 112 with the display signal from the signal source 106 and sends the combined signal to either a television or a computer monitor. In this embodiment, the receiver box 108 does not have to combine the status image 112 with the signal.

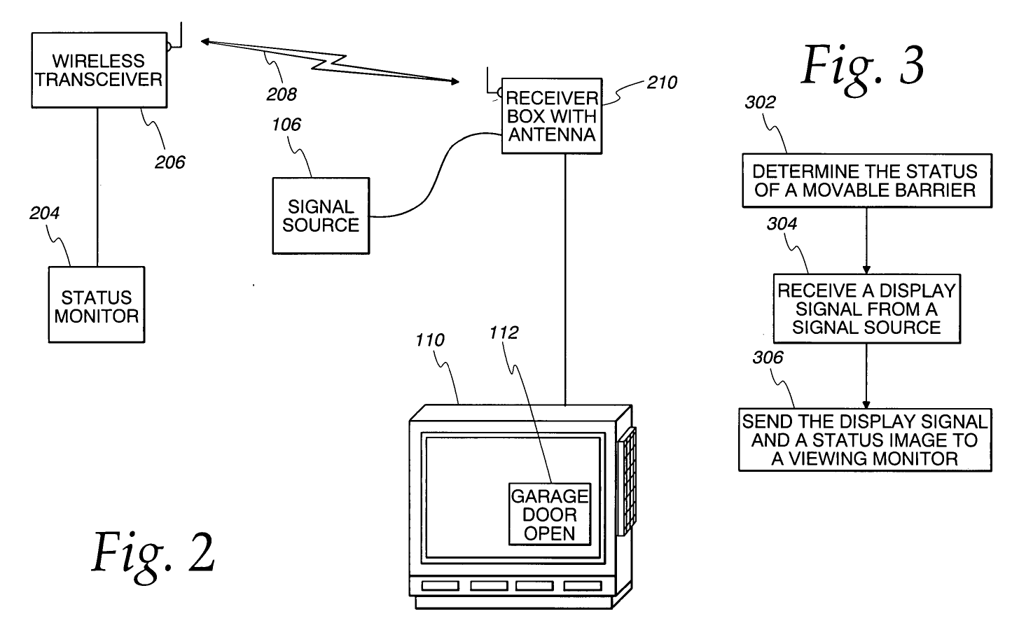

FIG. 2 illustrates a wireless system for monitoring a movable barrier 102. Shown is a status monitor 204, a wireless transmitter 206, a wireless channel 208, the signal source 106, a receiver box with an antenna 210, the status image 112, and the viewing monitor 110.

Generally, the movable barrier 102 is either open or closed, or in the process of opening or closing. As shown in FIG. 2 the status monitor 204 is attached to the door, detects the status of the door and sends the status signal to the receiver box 210 through the wireless transmitter 206. The indicated status may be, for example, open, closed, currently opening, currently closing, position from a limit, or a failure mode. The status monitor 204 may send the status signal to the receiver box 210 in response to a query by the receiver box 210. When so configured the transmitter 206 may include receiving capability while the receiver box 210 may be equipped with transmitting capabilities. The wireless communication mode is equally well suited to automatic and manually operated barriers.

In another embodiment the receiver box 210 itself determines the status of the movable barrier 102. The receiver box 210 determines whether to send the status image 112 to the viewing monitor 110 based upon the determination of the status of the movable barrier 102. When the receiver box 210 determines the status image 112 should be sent to the viewing monitor 110, the receiver box 210 sends the display signal received from the signal source 106 and the status image 112 to the viewing monitor 110. The viewing monitor 110 then displays both the status image 112 and display signal. Alternatively, the receiver box 210 combines the display signal and the status image 112 into a combined signal. The combined signal is then sent to the viewing monitor 110 for display. The display of the status image 112 on the viewing monitor 110 conveniently notifies a user of the viewing monitor 110 the status of the movable barrier 102.

As previously discussed the alerting system of the present description may be used with a computer display when such is the case the receiver box 210 can be connected to a communication port of a computer. For example, the receiver box 210 can be connected to a Universal Serial Bus (USB) port or an RS-232 port which is coupled to a computer. The receiver box 210 sends a status signal to the computer. The computer, determines if the status image 112 will be displayed on the viewing monitor 110, e.g., the computer monitor. If the computer determines that it should display the status image 112, the status image 112 will be sent to the viewing monitor 110 for display along with the “normal” display information being sent by the computer to the monitor. For example, in the Windows™ environment the status may appear as an icon on top of the display for a presently running application. The computer may be installed with a software program which determines what will be displayed on the computer based upon the signal from the receiver box 210.

When the display is a computer monitor, the status image 112 is combined with the signal that will be sent to a Video Graphics Array (VGA) monitor, e.g., the signal from a VGA card. Additionally, most displays sold today support the Ultra Extended Graphics Array (UXGA) standard. A typical UXGA adapter takes the digital data sent by application programs, stores it in video random access memory (VRAM) or some equivalent, and uses a digital-to-analog converter (DAC) to convert it to analog data for the display scanning mechanism. Once it is in analog form, the information is sent to the monitor through a VGA cable. Thus, the receiver box can send a signal through a communication port to the computer. An application on the computer will send data to the UXGA adapter and the data will eventually be sent through a VGA cable for display on the computer monitor. Alternatively, the computer monitor can be a digital monitor. In this embodiment, a digital signal is sent to the digital monitor, using for example, the Digital Video Interface (DVI) standard.

FIG. 3 illustrates a flow chart of one method in accordance with the embodiments shown in FIGS. 1 and 2. Shown is a determining step 302, a receiving step 304 and a sending step 306.

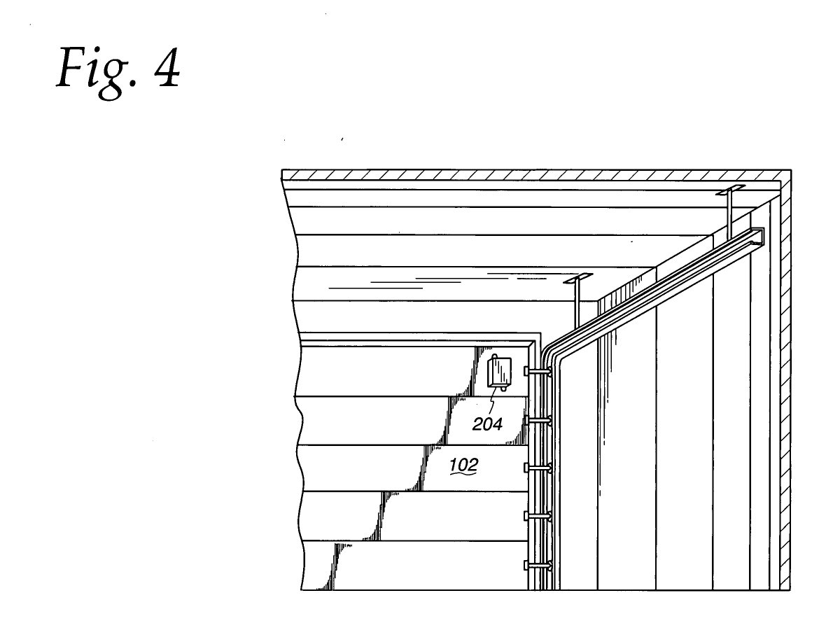

The determining step 302 comprises the receiver box 108 determining the status of a movable barrier 102, e.g., the movable barrier 102 described with reference to FIGS. 1 and 2. The status of the movable barrier 102 can be determined, e.g., by the movable barrier operator 104 sending a signal to the receiver box 108. Alternatively, the status of the movable barrier 102 can be determined by either the receiver box 108 monitoring an electrical connection to the movable barrier operator or by the status monitor 204, one example of which will be described in greater detail with reference to FIG. 4. The receiving step 304 comprises the receiver box 108 receiving a display signal from the signal source 106, e.g., the signal source 106 described with reference to FIGS. 1 and 2.

The sending step 306 comprises the receiver box 108 sending the display signal and a status image 112 to a viewing monitor 110, e.g., the viewing monitor 110 described with reference to FIGS. 1 and 2. It should be understood that the sending step 306 can include either sending both the display signal and the status image 112 to the viewing monitor 110 or sending a combined signal to the viewing monitor 110. The combined signal including both the status image 112 and the display signal. The method shown in FIG. 3 can operate similarly with the receiver box 210 shown in FIG. 2.

FIG. 4 is a perspective diagram illustrating a status monitor attached to a movable barrier. Shown is the movable barrier 102, and the status monitor 204. The status monitor 204 is attached to the movable barrier 102, such that when the movable barrier 102 changes position, e.g., opening or closing, the status monitor 204 detects the change in position. Advantageously, the status monitor can include an RF transmitter, such as is known in the art, for transmitting a status signal to the receiver box 108 (not shown in FIG. 4).

The status monitor 204 is known in the art. For example, a status monitor which could be used in accordance with the present invention is described in U.S. Pat. No. 5,402,105 to Doyle et al. While the invention herein disclosed has been described by means of specific embodiments and applications thereof, other modifications, variations, and arrangements of the present invention may be made in accordance with the above teachings other than as specifically described to practice the invention within the spirit and scope defined by the following claims.

What is claimed is:

1. Apparatus for monitoring a movable barrier comprising:
a movable barrier operator for controlling a movable barrier; and
a receiver box, electronically coupled to the movable barrier operator, for sending a status image combined with a display signal to a viewing monitor.

2. The apparatus of claim 1 wherein the viewing monitor is a television and the display signal comprises a television signal.

3. The apparatus of claim 1 wherein the viewing monitor is a computer monitor and the display signal comprises a computer monitor display signal.

4. The apparatus of claim 1 wherein the receiver box is electronically coupled to the movable barrier operator through a wireless channel.

5. The apparatus of claim 1 wherein the receiver box determines the status of the movable barrier.

6. The apparatus of claim 1 wherein the movable barrier operator sends a status signal to the receiver box.

7. The apparatus of claim 1 further comprising a signal source coupled to the receiver box.

8. The apparatus of claim 7 wherein the receiver box receives the display signal from the signal source.

9. The apparatus of claim 1 wherein the movable barrier operator is coupled to a wireless transmitter.

10. The apparatus of claim 1 wherein the movable barrier comprises a garage door.

11. A method of monitoring a movable barrier comprising the steps of:
determining a status of the movable barrier;
receiving a display signal from a signal source; and
sending a status image and the display signal to a viewing monitor.

12. A method of claim 11 further comprising the step of combining the display signal and the status image to create a combined signal.

13. A method of claim 12 further comprising the step of displaying the combined signal on the viewing monitor.

14. A method of claim 11 further comprising the steps of:
displaying the status image on the viewing monitor; and
displaying the display signal on the viewing monitor.

15. A method of claim 11 wherein the status of the movable barrier is open.

16. A method of claim 11 wherein the status of the movable barrier is closed.

17. A method of claim 11 wherein the movable barrier is a garage door.

18. A method of monitoring a movable barrier comprising the steps of:
receiving a status signal identifying a status of a movable barrier;
receiving a display signal from a signal source;
combining the display signal and the status signal to create a combined signal; and
conveying the combined signal to a viewing monitor.

19. A method of claim 18 further comprising the step of sending a query to a generator of the received status signal.

20. A method of claim 19 wherein the query is sent via a wireless channel.

21. A method of claim 18 wherein the movable barrier is a garage door.

22. A method of claim 18 wherein the combined signal is conveyed to a television.

23. A method of claim 22 wherein the display signal is a television signal.

24. A method of monitoring a movable barrier comprising the steps of:
determining a status of the movable barrier; and
sending a status image to a viewing monitor;
wherein the status image is shown on the viewing monitor simultaneously with a display signal from a signal source.

25. A method of claim 24 comprising the steps of:
receiving the display signal from the signal source; and
sending the display signal to the viewing monitor.

26. A method of claim 24 further comprising the step of combining the display signal and the status image.

27. A method of claim 24 wherein the viewing monitor is a television.

28. A method of claim 24 wherein the viewing monitor is a computer monitor.

29. A method of monitoring a movable barrier comprising the steps of:
receiving a status signal from a status monitor;
determining a status of the movable barrier; and
outputting a status image signal for display on a television.

30. A method of claim 29 further comprising the step of combining the status image signal with a display signal from a signal source to create a combined signal.

31. A method of claim 29 further comprising the step of displaying the status image signal simultaneously with a display signal on the television.

32. A method of monitoring a movable barrier comprising the steps of:
receiving a status signal from a status monitor;
determining a status of the movable barrier; and
outputting a status image signal for display on a computer monitor.

33. A method of claim 32 further comprising the step of combining the status image signal with a display signal from a signal source to create a combined signal.

34. A method of claim 32 further comprising the step of displaying the status image signal simultaneously with a display signal on the computer monitor.

35. Apparatus for monitoring a movable barrier comprising:
a barrier status sensor for generating status signals representing the status of the barrier;
a source of display signals;
apparatus for combining the display signals with the status signals and presenting the combined status and display signals on a viewing monitor.

36. The apparatus of claim 35 wherein the viewing monitor comprises a television and the display signals comprise television program signals.

37. The apparatus of claim 35 wherein the viewing monitor comprises a computer monitor and the display signals comprise display signals generated by a computer program.

38. The apparatus of claim 35 wherein the source of display signals comprises a television signal receiving antenna.

39. The apparatus of claim 35 wherein the source of display signals comprises a cable television feed.
